(19) United States
(12) Patent Application Publication
(10) Pub. No.: US 2016/0061288 A1
(43) Pub. Date: Mar. 3, 2016

(54) FLYWHEEL

(71) Applicant: JTEKT CORPORATION, Osaka (JP)

(72) Inventors: Daisuke OZAKI, Kitakatsuragi-gun (JP); Ryouichi TAKAHATA, Kitakatsuragi-gun (JP); Katsutoshi NISHIZAKI, Higashiosaka-shi (JP)

(21) Appl. No.: 14/820,300

(22) Filed: Aug. 6, 2015

(30) Foreign Application Priority Data
Aug. 29, 2014 (JP) 2014-176224

(51) Int. Cl. F16F 15/305; F16F 15/30

(52) U.S. Cl. CPC F16F 15/305; F16F 15/30

(57) ABSTRACT

A flywheel includes a wheel ring and a hub ring fitted into the wheel ring. A hub ring main body of the hub ring pressure-contacts an inner periphery of the wheel ring while the flywheel is rotating. The pressure contact of the hub ring with the inner periphery of the wheel ring allows compressive stress applied to the wheel ring in a radial direction to cancel a portion of tensile stress acting in the wheel ring in the radial direction. As a result, the stress in the wheel ring in the radial direction decreases.

### INCORPORATION BY REFERENCE

The disclosure of Japanese Patent Application No. 2014-176224 filed on Aug. 29, 2014 including the specification, drawings and abstract, is incorporated herein by reference in its entirety.

### BACKGROUND OF THE INVENTION

1. Field of the Invention

The present invention relates to a flywheel that is mounted in a flywheel battery apparatus and the like and that rotates to store inertia energy.

2. Description of Related Art

Flywheel battery apparatuses have been known which convert electric energy into rotational inertia energy and store the resultant energy. In regard to the material for a flywheel mounted in the flywheel battery apparatus, there has been a need for a material with a high specific strength (a value resulting from division of material strength by density) in order to withstand a centrifugal force generated during high speed rotation. To achieve a high weight energy density, a part of the flywheel that contributes only insignificantly to energy is desirably removed.

Thus, a flywheel has been proposed which is a hollow cylinder and which is formed of a carbon-fiber-reinforced plastic (CFRP) (see Japanese Patent Application Publication No. H9-267402 (JP H9-267402 A)). The flywheel described in JP H9-267402 A is configured as an integral member, and reinforcing fibers in the fiber-reinforced plastic are oriented in a circumferential direction (that is, a rotating direction of the flywheel).

The weight energy density of the flywheel battery apparatus depends on the outermost peripheral speed of the flywheel. Thus, for an increased energy density of the flywheel, the flywheel is desirably rotated as fast as possible. However, an increased rotation speed of the flywheel causes the flywheel to be expanded outward in a radial direction due to a centrifugal force resulting from rotation of the flywheel. Consequently, the flywheel may be significantly internally distorted. As a result, high stress may be generated inside the flywheel.

The present inventors have been making effort to increase the speed of the flywheel (for example, to increase the outermost peripheral speed of the flywheel from a current value of approximately 800 (m/sec) to 1500 (m/sec) or higher). However, the flywheel as described in JP H9-267402 A, in which the reinforcing fibers are oriented in the circumferential direction, has a low strength in a radial direction. When such a flywheel is rotated at such a high speed, the magnitude of radial stress generated in the flywheel (a radial component of the stress) is likely to exceed the material strength. Thus, such a high speed may fail to be achieved. Therefore, the present inventors have been making effort to reduce the radial stress generated inside the flywheel during rotation by improving the structure of the flywheel.

### SUMMARY OF THE INVENTION

An object of the present invention is to provide a flywheel that allows a reduction in radial stress generated inside the flywheel during rotation, enabling rotation at a higher speed.

A flywheel in an aspect of the present invention rotates around a predetermined axis of rotation to store inertia energy and includes a ring member and a hub ring fitted into the ring member. The hub ring pressure-contacts an inner periphery of the ring member at least while the flywheel is rotating.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view depicting a configuration of a flywheel according to a first embodiment of the present invention;

FIG. 2 is a sectional view of the flywheel;

FIG. 3 is a perspective view depicting a configuration of a divided element included in the flywheel;

FIG. 4 is a diagram depicting a configuration of a carbon fiber prepreg included in the divided element;

FIG. 5 is a perspective view depicting a configuration of a divided element included in a hub ring according to a second embodiment of the present invention;

FIG. 6 is a perspective view depicting a configuration of a divided element included in a hub ring according to a third embodiment of the present invention;

FIG. 7 is a perspective view depicting a configuration of a flywheel according to a fourth embodiment of the present invention;

FIG. 8 is a sectional view of a flywheel according to a fifth embodiment of the present invention;

FIG. 9 is a graph illustrating results of internal stress test according to an example; and

FIG. 10 is a graph illustrating results of internal stress test according to a comparative example.

### DETAILED DESCRIPTION OF EMBODIMENTS

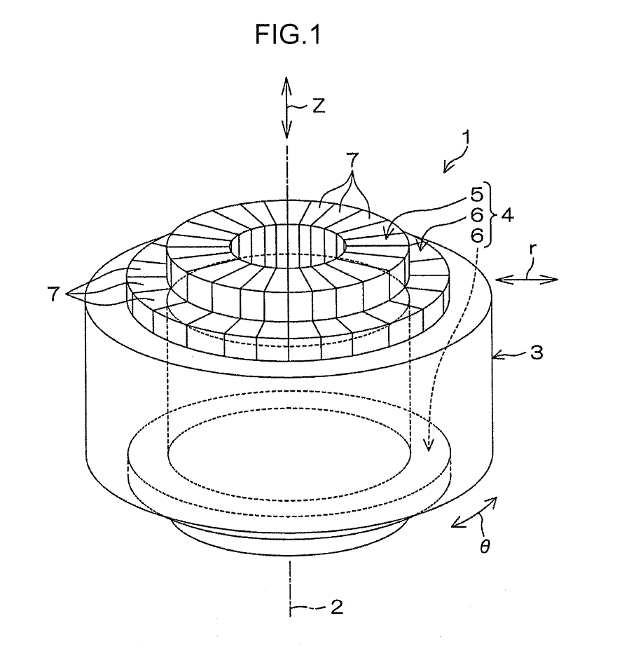

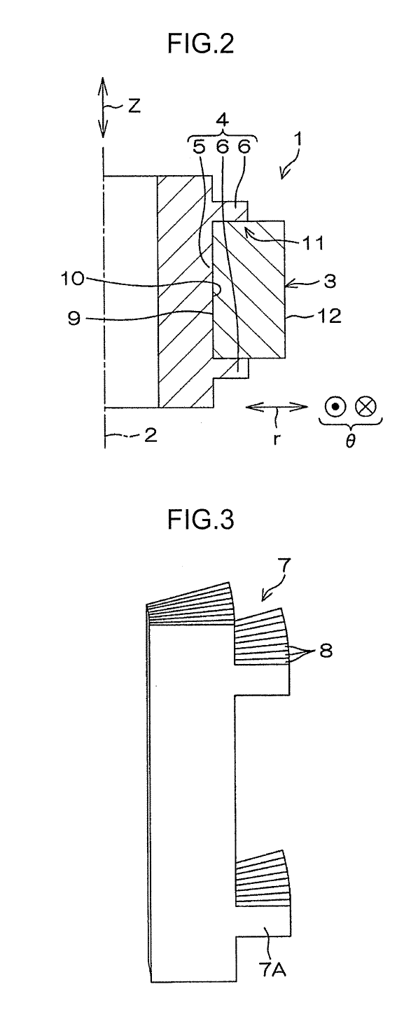

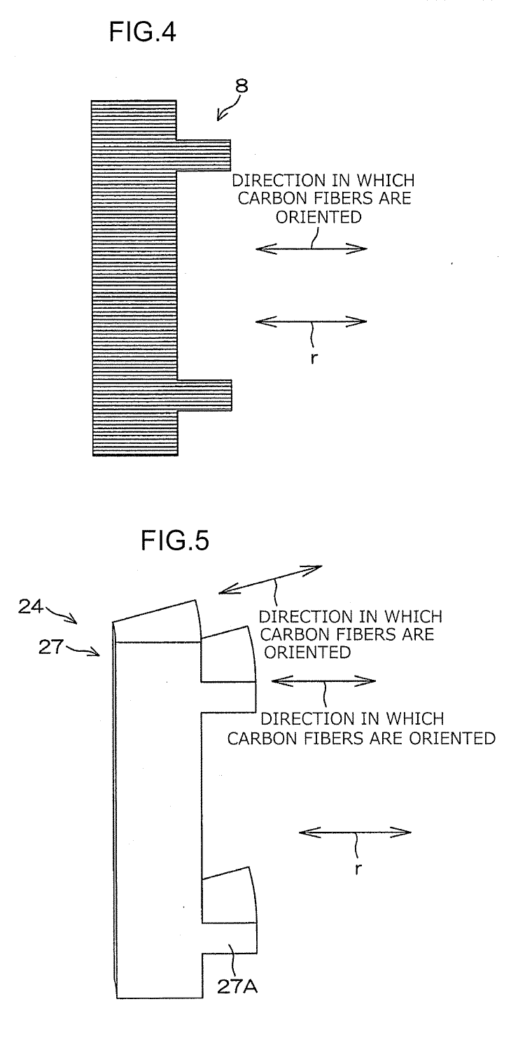

Embodiments of the present invention will be described below with reference to the attached drawings. FIG. 1 is a perspective view depicting a configuration of a flywheel 1 according to a first embodiment of the present invention. FIG. 2 is a sectional view of the flywheel 1. FIG. 3 is a perspective view depicting a configuration of a divided element 7 included in the flywheel 1. FIG. 4 is a diagram depicting a configuration of a carbon fiber prepreg 8 included in the divided element 7.

The flywheel 1 is hollow and generally cylindrical, and is mounted in a flywheel battery apparatus (not depicted in the drawings). In the flywheel battery apparatus, the flywheel 1 is provided so as to be rotatable, in a horizontal orientation, around a vertical axis of rotation 2, for example. Components such as a rotating shaft (not depicted in the drawings) extending along the axis of rotation 2 and electrical components are housed in a hollow portion of the flywheel 1. Since the components are housed in the hollow portion of the flywheel 1, the flywheel battery apparatus is compact.

The flywheel 1 includes an assembly of a wheel ring (ring member) 3 and a hub ring 4 fitted into the wheel ring 3. The wheel ring 3 and the hub ring 4 are provided coaxially around the axis of rotation 2. A direction in which the axis of rotation 2 extends is hereinafter referred to as an axial direction z. A radial direction of the flywheel 1 is hereinafter referred to as a radial direction r. The radial direction r coincides with a direction of turning radius of the flywheel 1. Moreover, a circumferential direction of the flywheel 1 (wheel ring 3 and hub ring 4) is hereinafter referred to as a circumferential direction θ. A “radial stress” as used herein refers to a “radial component of the stress”, and a “circumferential stress” as used herein refers to a “circumferential component of the stress”.

The wheel ring 3 is cylindrical. The wheel ring 3 has an outer diameter of approximately 450 (mm). The wheel ring 3 is formed of CFRP that is an example of fiber-reinforced plastic, Carbon fibers in the wheel ring 3 are oriented mostly in the circumferential direction θ. That is, substantially no carbon fibers in the wheel ring 3 are oriented in the axial direction z or the radial direction r. Thus, the wheel ring 3 has a high rigidity and a high strength in the circumferential direction θ and a low rigidity and a low strength in the radial direction r. The wheel ring 3 is formed by what is called a filament winding method in which tows (untwisted long fiber bundles containing a large number of filaments) impregnated with resin are wound around a cylinder or a pressure container and then cured.

The hub ring 4 has a cylindrical hub ring main body 5 integrated with a pair of disc-shaped flanges 6, The hub ring main body 5 is held in an orientation perpendicular to the axis of rotation 2 (horizontal orientation). The flanges 6 project outward in the radial direction r from the vicinities of opposite ends of the hub ring main body 5 in the axial direction z. A housing space 11 in which the wheel ring 3 is housed is defined by an outer peripheral surface 10 of the whole of the hub ring main body 5 except for opposite ends thereof in the axial direction z and inside principal surfaces of the pair of flanges 6 (a lower surface of the upper flange 6 and an upper surface of the lower flange 6). With the hub ring 4 fitted into the wheel ring 3, the outer peripheral surface 10 of the hub ring main body 5 is in abutting contact with an inner peripheral surface 9 of the wheel ring 3 or faces the inner peripheral surface 9 at a very short distance therefrom.

The distance between the pair of disc-shaped flanges 6 in the axial direction z is set equivalent to the length of the wheel ring 3 in the axial direction z. An outer peripheral end of the pair of flanges 6 is positioned inward of an outer peripheral surface 12 of the wheel ring 3 in the radial direction r. That is, an outer diameter of the flanges 6 is set smaller than an outer diameter of the wheel ring 3, and for example, to approximately 300 (mm). An outer diameter of the hub ring main body 5 is set equivalent to an inner diameter of the wheel ring 3, and for example, to approximately 240 (mm).

The hub ring 4 is formed of CFRP. Carbon fibers in the hub ring 4 are oriented mostly in the radial direction r. That is, the carbon fibers in the hub ring 4 are not oriented in the axial direction z or the circumferential direction θ. Thus, the hub ring 4 has a high rigidity and a high strength in the radial direction r and a low rigidity and a low strength in the circumferential direction θ. The hub ring 4 is divided into a plurality of equal pieces (in FIG. 1, for example, 24 equal pieces). In other words, the hub ring 4 is divided into the pieces in the circumferential direction θ using division surfaces 7A (see FIG. 3) perpendicular to the circumferential direction θ. Dividing the hub ring 4 into the pieces in the circumferential direction θ enables a further reduction in the rigidity of the whole hub ring 4 in the circumferential direction θ. This allows the hub ring 4 with a reduced rigidity in the circumferential direction θ to be implemented using a relatively simple configuration.

As depicted in FIG. 3 and FIG. 4, each of the divided elements 7 is formed by a prepreg method. Specifically, the divided element 7 is formed by laminating prepregs 8 together in the circumferential direction θ. Each carbon fiber prepreg 8 is shaped like a sheet and includes carbon fibers impregnated with a matrix resin (for example, an epoxy resin). Each carbon fiber prepreg 8 has a shape conforming to the sectional shape of the divided element 7 along the radial direction. The carbon fibers in the carbon fiber prepreg 8 are oriented only in a width direction of the carbon fiber prepreg 8 (direction orthogonal to a longitudinal direction). The divided element 7 depicted in FIG. 3 is obtained by laminating the carbon fiber prepregs 8 only in the circumferential direction θ and then curing the resultant carbon fiber prepreg 8 using a matrix resin (for example, an epoxy resin). Consequently, the divided element 7 which is formed of CFRP and in which the carbon fibers are oriented only in the radial direction r can be obtained using a relatively simple configuration.

When the flywheel 1 is produced, the divided elements 7 are fitted into the wheel ring 3, for example, one by one, such that all the divided elements 7 are finally arranged in the circumferential direction θ, thus forming the hub ring 4 including ring elements. Consequently, the hub ring 4 can be fitted into the wheel ring 3. In this state, the outer peripheral surface 10 of the hub ring main body 5 is in abutting contact with the inner peripheral surface 9 of the wheel ring 3 or faces the inner peripheral surface 9 at a very short distance therefrom. Furthermore, in this state, the lower flange 6 is in surface contact with the wheel ring 3 from below to support the wheel ring 3. This allows the wheel ring 3 to be prevented from falling from the hub ring 4.

In the flywheel battery apparatus (not depicted in the drawings), the flywheel 1 is rotated around the axis of rotation 2 at a very high speed (for example, the flywheel 1 has an outermost peripheral speed of 1200 (m/sec) or higher (for example, approximately 1500 (m/sec))). In this case, the flywheel 1 has a weight energy density of approximately 200 (Wh/kg). When rotated at a high speed, the flywheel 1 is subjected to a centrifugal force resulting from rotation of the flywheel 1 and expanded outward in the radial direction r. As a result, the flywheel 1 is internally distorted, generating tensile stress inside the wheel ring 3. The rigidity of the hub ring 4 in the circumferential direction θ is set lower than the rigidity of the wheel ring 3 in the circumferential direction θ. Consequently, when subjected to the centrifugal force generated during rotation of the flywheel 1, the hub ring main body 5 is more likely to be expanded outward in the radial direction than the wheel ring 3. Therefore, while the flywheel 1 is rotating, the hub ring main body 5, which is expanded more outward in the radial direction r, pressure-contacts an inner periphery of the wheel ring 3.

The pressure contact of the hub ring 4 with the inner periphery of the wheel ring 3 causes compressive stress to be applied to wheel ring 3 in the radial direction r. The hub ring 4, which has a high rigidity in the radial direction r, contacts the inner peripheral surface 9 of the wheel ring 3 in the radial direction r. This allows the compressive stress in the radial direction r to be efficiently applied to the wheel ring 3. The compressive stress thus applied in the radial direction r cancels a portion of the tensile stress in the wheel ring 3 in the radial direction r. As a result, the stress in the wheel ring 3 in the radial direction r decreases. Therefore, compared to a case where the flywheel 1 is provided as an integral member, the present embodiment enables a reduction in the stress generated inside the flywheel 1 in the radial direction r while the flywheel 1 is rotating.

Since the hub ring 4 included in the flywheel 1 has a low rigidity in the circumferential direction θ of the hub ring 4, the stress in the circumferential direction 0 can be reduced which is generated inside the flywheel 1 while the flywheel 1 is rotating.

Moreover, since the hub ring 4 includes the plurality of divided elements 7 arranged in the circumferential direction θ, the rigidity of the whole hub ring 4 in the circumferential direction θ can be reduced. Consequently, the stress can further be reduced which is generated inside the flywheel 1 while the flywheel 1 is rotating.

As described above, the stress (both the stress in the radial direction r and the stress in the circumferential direction θ) can be reduced which is generated inside the flywheel 1 while the flywheel 1 is rotating. Consequently, the flywheel 1 can be provided which enables rotation at higher speed. In addition, the flanges 6 included in the hub ring 4 each have the reduced outer diameter, allowing the centrifugal force acting on the hub ring 4 to be suppressed. This enables prevention of an increase in the stress generated inside the flywheel 1 in association with the flanges 6 of the hub ring 4. A change in the outer diameter of the flange 6 also enables the centrifugal force acting on the hub ring 4 to be appropriately adjusted.

Since the direction in which the carbon fibers in the wheel ring 3 are oriented is the circumferential direction θ, the wheel ring 3 has a high rigidity and a high strength in the circumferential direction θ. Therefore, even when the rigidity of the hub ring 4 included in the flywheel 1 is set low in the circumferential direction θ, the flywheel 1 as a whole can still have a high rigidity and a high strength in the circumferential direction θ. FIG. 5 is a perspective view depicting a configuration of a divided element 27 included in a hub ring 24 according to a second embodiment of the present invention.

The hub ring 4 is divided into a plurality of equal pieces (for example, 24 equal pieces). In other words, the hub ring 24 is divided into the pieces in the circumferential direction θ by division surfaces 27A perpendicular to the circumferential direction θ. As a result, the hub ring 24 includes the plurality of (for example, 24) divided elements 27. The divided element 27 according to the second embodiment is different from the divided element 7 according to the first embodiment (see FIG. 1 or the like) in that the divided element 27 is formed using a technique different from the prepreg method.

The divided element 27 is formed of three-dimensional carbon fiber fabric. The divided element 27 is obtained by executing a converging process (covering process) on carbon fibers, weaving the resultant threads into carbon fiber fabrics, laminating a plurality of carbon fiber fabrics together, sewing the carbon fiber fabrics together using in-plane threads in accordance with an image processing sewing method, and then executing a scouring process on the resultant fabrics. Like the divided element 7, the divided element 27 formed of the three-dimensional carbon fiber fabric is provided such that the carbon fibers are oriented in the radial direction.

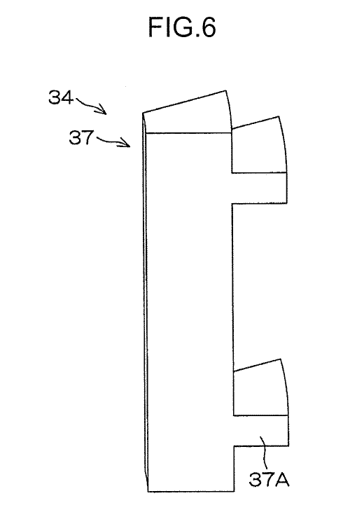

The second embodiment provides advantageous effects equivalent to those described in connection with the first embodiment. FIG. 6 is a perspective view depicting a configuration of a divided element 37 included in a hub ring 34 according to a third embodiment of the present invention. The hub ring 34 is divided into a plurality of equal pieces (for example, 24 equal pieces) in the circumferential direction θ. In other words, the hub ring 34 is divided into the pieces in the circumferential direction θ by division surfaces 37A perpendicular to the circumferential direction θ. As a result, the hub ring 34 includes the plurality of (for example, 24) divided elements 27.

The divided element 37 according to the third embodiment is different from the divided elements 7 and 27 according to the first and second embodiments (see FIG. 1 and FIG. 5) in that the divided element 37 is formed of a steel material instead of CFRP. A specific example of the steel material is high tensile strength steels. The third embodiment provides advantageous effects equivalent to those described in connection with the first embodiment.

A material for the divided element 37 may be a metal material other than the steel material, for example, high-strength aluminum alloy. In the first to third embodiments, the configuration has been described in which the divided elements 7, 27, or 37 are formed by dividing the corresponding ring element into 24 equal pieces in the circumferential direction θ. However, the number of the equal pieces is not limited to 24, and a different number of, for example, 2, 3, 4, 6, or 12 pieces may be formed. Alternatively, the divided elements may be formed by dividing the ring element into unequal pieces.

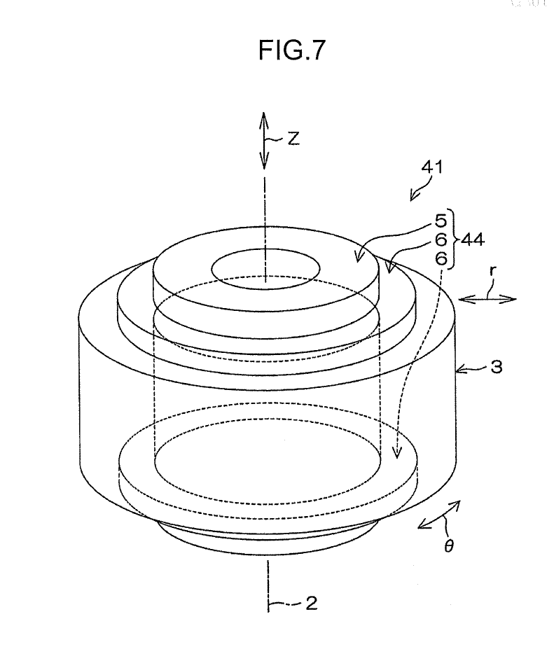

FIG. 7 is a perspective view depicting a configuration of a flywheel 41 according to a fourth embodiment of the present invention. Components in the fourth embodiment that are common to those in the first embodiment are denoted by the same reference numerals as those in FIG. 1 and will not be described below. A flywheel 41 according to the fourth embodiment is different from the flywheel 1 according to the first and second embodiments in that the flywheel 41 includes a hub ring 44 instead of the hub rings 4 and 24 (see, for example, FIG. 1 and FIG. 5 or the like). The hub ring 44 is formed of an integral member instead of a plurality of divided elements. Like the hub rings 4 and 24, the hub ring 44 is provided such that the direction in which the carbon fibers are oriented is the radial direction r. The hub ring 44 is formed of three-dimensional carbon fiber fabric similarly to the divided element 27 included in the hub ring 24. The hub ring 44 is obtained by executing the converging process (covering process) on the carbon fibers, weaving the resultant threads into carbon fiber fabrics, laminating a plurality of carbon fiber fabrics together, sewing the carbon fiber fabrics together using in-plane threads in accordance with the image processing sewing method, and then executing the scouring process on the resultant fabrics.

The fourth embodiment provides advantageous effects equivalent to those described in connection with the first embodiment except advantageous effects related to the divided element 7. When the metal material such as a steel material is used as a material for the hub ring, it is not preferable that the hub ring be an integral member as is the case with the fourth embodiment. That is, when the steel material is used as a material for the hub ring, the hub ring preferably has a divided structure. This is because a hub ring formed of the steel material has a high rigidity in the circumferential direction θ and the hub ring configured as an integral member fails to enable a sufficient reduction in the stress generated inside the flywheel while the flywheel is rotating.

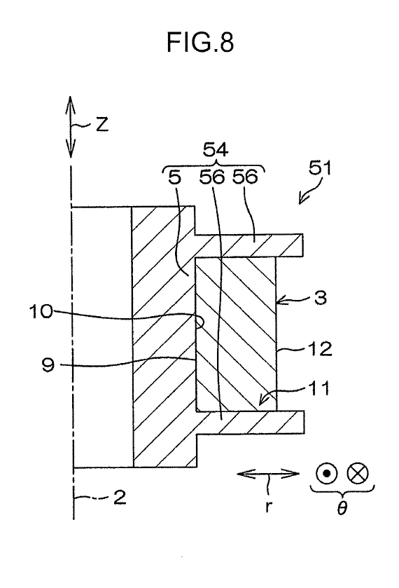

FIG. 8 is a sectional view of a flywheel 51 according to a fifth embodiment of the present invention. Components of the fifth embodiment common to those in the first embodiment are denoted by the same reference numerals as those in FIG. 1 and will not be described below. The flywheel 51 according to the fifth embodiment is different from the flywheel 1 according to the first embodiment (see FIG. 1 or the like) in that the hub ring 4 (see FIG. 1 or the like) is replaced with a hub ring 54 having a pair of flanges 56 with outer peripheral ends projecting outward of an outer peripheral surface 12 of the wheel ring 3 in the radial direction r.

The outer diameter of the flange (flange 6 or 56) is changed to allow adjustment of the magnitude of the centrifugal force acting on the hub ring (hub ring 4 or 54). That is, a reduced outer diameter of the flange results in a reduced centrifugal force acting on the hub ring. An increased outer diameter of the flange results in an increased centrifugal force acting on the hub ring. The outer diameter of the flange 56 according to the fifth embodiment is larger than the outer diameter of the flange 6 according to the first embodiment (see FIG. 2 or the like). Thus, the centrifugal force acting on the hub ring 54 according to the fifth embodiment is higher than the centrifugal force acting on the hub ring 4 according to the first embodiment. In this case, the stress generated in the hub ring 54 in the circumferential direction θ while the flywheel 51 is rotating is higher than the stress in the case of the hub ring 4.

The fifth embodiment provides advantageous effects equivalent to those described in connection with the first embodiment except advantageous effects related to a reduction in the outer diameter of the flange 6 of the hub ring 4. The fifth embodiment may be combined with the second to fourth embodiments. Now, internal stress tests will be described.

In an example and a comparative example described below, the stress generated inside the flywheel during high speed rotation was determined by analysis based on a finite element method (FEM). A rotation speed for each of the flywheels was set to 60,000 (rpm) (the outermost peripheral speed in this case was set to 1,400 (m/sec)).

Example: A measurement target was the flywheel 51 according to the fifth embodiment. The inner diameter dimension of the hub ring main body 5 was set to 220 (mm), the outer diameter dimension of the flange 56 was set to 260 (mm), and the thickness of the flange 56 in the axial direction z was set to 10 (mm). The inner diameter dimension of the wheel ring 3 was set to 240 (mm), the outer diameter dimension of the wheel ring 3 was set to 500 (mm), and the dimension of the wheel ring 3 in the axial direction z was set to 200 (mm).

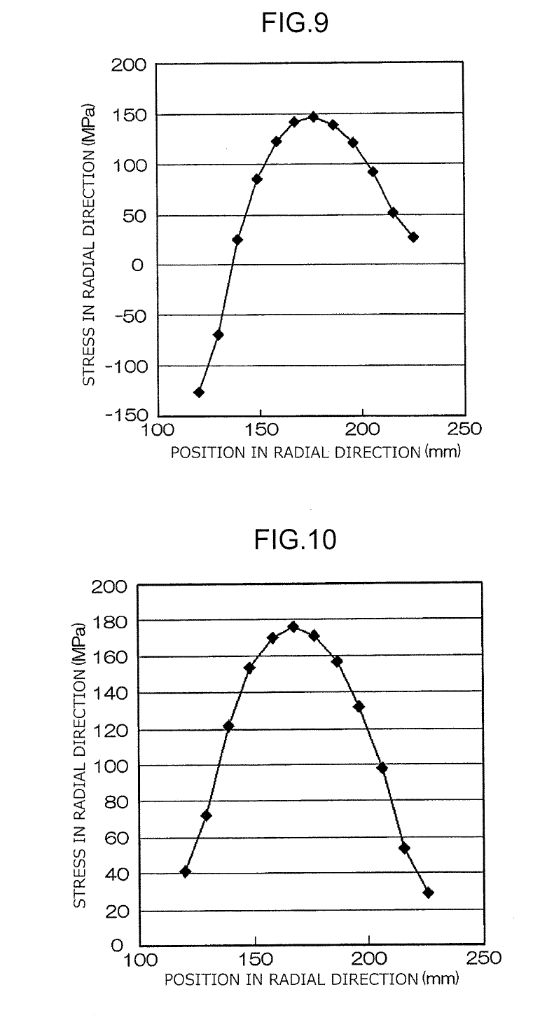

Comparative example: A measurement target was a flywheel formed of CFRP and configured as an integral member. The inner diameter dimension of the flywheel was set to 240 (mm), the outer diameter dimension of the flywheel was set to 450 (mm), and the dimension of the flywheel in the axial direction z was set to 200 (mm). Under these conditions, the in-plane distribution of the stress in the radial direction r in the vicinity of a central position in the wheel ring (flywheel) in the axial direction z was arithmetically determined. FIG. 9 depicts the in-plane distribution of the stress in the radial direction r in the example, and FIG. 10 depicts the in-plane distribution of the stress in the radial direction r in the comparative example. In FIG. 9 and FIG. 10, a reference for a radial position (that is, “zero”) is the axis of rotation 2.

The results depicted in FIG. 9 indicate that, in the example, the stress in the radial direction r is lower than a strength upper limit value at all positions in the radial direction r. On the other hand, the results depicted in FIG. 10 indicate that, in the comparative example, the stress in the radial direction r is higher than the strength limit value at a central portion of the flywheel in the radial direction r. The five embodiments of the present invention have been described. However, the present invention can also be implemented in other embodiments.

For example, CFRP is preferable as fiber-reinforced plastic. However, fiber-reinforced plastic containing fibers other than carbon fibers such as glass fibers, boron fibers, or aramid fibers may be used as a base material for the wheel ring 3 and/or the hub rings 4, 24, 34, 44, or 54. The epoxy resin has been taken as an example of the matrix resin of the fiber-reinforced plastic. However, the matrix resin may be an unsaturated polyester resin, a vinyl ester resin, an epoxy resin, a phenol resin, a polyamide resin, a polyimide resin, a furan resin, a maleimide resin, an acrylic resin, or the like.

Various changes may be made to the embodiments within the scope of the claims.

What is claimed is:

1. A flywheel that rotates around a predetermined axis of rotation to store inertia energy, the flywheel comprising:
a ring member; and
a hub ring fitted into the ring member, wherein
the hub ring pressure-contacts an inner periphery of the ring member at least while the flywheel is rotating.

2. The flywheel according to claim 1, wherein a rigidity of the hub ring in a circumferential direction is set lower than a rigidity of the ring member in the circumferential direction, and
a rigidity of the hub ring in a radial direction is set higher than a rigidity of the ring member in the radial direction.

3. The flywheel according to claim 1, wherein the hub ring includes a plurality of divided elements obtained by dividing, in the circumferential direction, the hub ring with a plurality of division surfaces perpendicular to the circumferential direction.

4. The flywheel according to claim 2, wherein the hub ring includes a plurality of divided elements obtained by dividing, in the circumferential direction, the hub ring with a plurality of division surfaces perpendicular to the circumferential direction.

5. The flywheel according to claim 1, wherein the hub ring has a cylindrical hub ring main body and a disc-shaped flange projecting outward in the radial direction from the hub ring main body, and the flange is in abutting contact with the ring member from below in order to support the ring member.

6. The flywheel according to claim 2, wherein the hub ring has a cylindrical hub ring main body and a disc-shaped flange projecting outward in the radial direction from the hub ring main body, and the flange is in abutting contact with the ring member from below in order to support the ring member.

7. The flywheel according to claim 3, wherein the hub ring has a cylindrical hub ring main body and a disc-shaped flange projecting outward in the radial direction from the hub ring main body, and the flange is in abutting contact with the ring member from below in order to support the ring member.

8. The flywheel according to claim 4, wherein the hub ring has a cylindrical hub ring main body and a disc-shaped flange projecting outward in the radial direction from the hub ring main body, and the flange is in abutting contact with the ring member from below in order to support the ring member.

9. The flywheel according to claim 1, wherein the ring member is formed of a fiber-reinforced plastic, and a direction in which reinforcing fibers in the fiber-reinforced plastic are oriented is the circumferential direction of the ring member.

10. The flywheel according to claim 2, wherein the ring member is formed of a fiber-reinforced plastic, and a direction in which reinforcing fibers in the fiber-reinforced plastic are oriented is the circumferential direction of the ring member.

11. The flywheel according to claim 3, wherein the ring member is formed of a fiber-reinforced plastic, and a direction in which reinforcing fibers in the fiber-reinforced plastic are oriented is the circumferential direction of the ring member.

12. The flywheel according to claim 4, wherein the ring member is formed of a fiber-reinforced plastic, and a direction in which reinforcing fibers in the fiber-reinforced plastic are oriented is the circumferential direction of the ring member.

13. The flywheel according to claim 5, wherein the ring member is formed of a fiber-reinforced plastic, and a direction in which reinforcing fibers in the fiber-reinforced plastic are oriented is the circumferential direction of the ring member.

14. The flywheel according to claim 6, wherein the ring member is formed of a fiber-reinforced plastic, and a direction in which reinforcing fibers in the fiber-reinforced plastic are oriented is the circumferential direction of the ring member.

15. The flywheel according to claim 7, wherein the ring member is formed of a fiber-reinforced plastic, and a direction in which reinforcing fibers in the fiber-reinforced plastic are oriented is the circumferential direction of the ring member.

16. The flywheel according to claim 8, wherein the ring member is formed of a fiber-reinforced plastic, and a direction in which reinforcing fibers in the fiber-reinforced plastic are oriented is the circumferential direction of the ring member.
